(19) United States
(12) Patent Application Publication
(10) Pub. No.: US 2015/0107465 A1
(43) Pub. Date: Apr. 23, 2015

(54) Sandwich Making Machine and Related Apparatus, Systems, and Methods

(71) Applicant: Blue Matrix Labs, LLC, Austin, TX (US)

(72) Inventors: Kendall D. Harter, Spicewood, TX (US); A. Scott Goodwin, Farmers Branch, TX (US); Jon Y. Yamamoto, Farmers Branch, TX (US)

(73) Assignee: Blue Matrix Labs, LLC, Austin, TX (US)

(21) Appl. No.: 14/250,202

(22) Filed: Apr. 10, 2014

Related U.S. Application Data
(60) Provisional application No. 61/894,255, filed on Oct. 22, 2013.

(51) Int. Cl. A21C 15/00

(52) U.S. Cl. CPC A21C 15/002
USPC 99/450.4

(57) ABSTRACT

Methods, systems, apparatus, etc. for making sandwiches. For instance, some systems comprise flowable-foodstuff bags and sandwich making apparatus. The apparatus comprise trays, presses, and drives. The trays hold bread while the presses press the foodstuff out of the bags. Moreover, the presses hold the bags in fixed relation to the trays. The drives operatively couple to the tray and press and drives the press and tray to spread the foodstuff on the bread. Some apparatus include features that fix/register the relative positions of the bag and tray. Those registration features can be bite-shaped. If desired, the bag and tray can be spaced apart from one another.

### CROSS-REFERENCE TO RELATED APPLICATIONS

This application claims priority to U.S. provisional patent application No. 61/894,255, titled Sandwich Making Machine, filed on Oct. 22, 2013, by Harter et al, the entirety of which is incorporated herein as if set forth in full.

### BACKGROUND

Children love sandwiches of many varieties. For instance, peanut butter and jelly sandwiches are a staple in the lives of children of all ages from toddlers, pre-teens, to teenagers, and even others. Other popular sandwich fillings include pulled/barbequed pork, pulled beef, pulled chicken, chicken salad, tuna salad, chipped beef, sloppy joe, vegemite, etc. Of course, many people enjoy sandwiches with various condiments spread on the bread of the sandwich. These condiments include catsup, mustard, mayonnaise, jam (if it is not one of the major components of the sandwich), butter, margarine, barbeque sauce, teriyaki sauce, soy sauce, horseradish, chutney, guacamole, and other sauces, spreads, etc. too numerous to list conveniently herein. Thus, sandwiches come in large varieties and can be prepared with many different ingredients.

However, preparing sandwiches (especially in large numbers) can be inconvenient, time-consuming, and messy among other things. The spreadable ingredients such as those listed above can get on counter tops, hands, clothing, etc. and can even cross contaminate other foodstuffs. For instance, a butter knife used to spread mayonnaise can transfer small bread particles (i.e., gluten) from one sandwich to the next. While most humans tolerate gluten quite well, some do not and can have rather pronounced reactions to even minute amounts of gluten. While perhaps not as serious as gluten-contamination, the act of preparing numerous sandwiches can leave the preparation area messy, thereby necessitating that other food preparation activities stop while users clean the area. Of course, affected clothing may need to be laundered thereby further increasing the work load of those involved.

Those involved in preparing sandwiches, moreover, might have many other items requiring their attention. For instance, in a restaurant setting, staff typically greet customers, seat them, take their orders, prepare their food, serve the food to them, attend to their wishes during the meal, and/or clear the table thereafter as well as washing the dishes and other related activities. During peak service times these activities add up often resulting in over-taxed kitchen teams. But, even in familial settings these activities (taken together along with other activities) can become burdensome. For instance, mothers might find themselves trying to prepare food for one child while another child is experiencing “issues” of any of a number of varieties. It also frequently occurs that a particular user (for instance, a particular parent) might want to prepare food for a party or other large gathering. While preparing in advance might offer a way to spread the work out over time, the work remains to be performed and taking some of that work off the hands of the preparer would allow him/her to attend to other tasks.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for making sandwiches and, more particularly, sandwich making apparatus, packages, etc. for use with sandwich making apparatus, and related systems and methods.

Furthermore, the current disclosure provides (among other things), new and non-obvious kitchen appliances that ease the workload on mothers and other caregivers. More specifically, embodiments provide machines that make sandwiches. These sandwiches, of course, have a piece(s) of bread and a spreadable condiment, ingredient, or component on the bread. The appliances of the current embodiment reduce the task of making sandwiches to placing a piece of bread on a tray and placing a bag of the ingredient on a hook in the apparatus. The apparatus spreads the ingredient on the bread at the touch of a button. It therefore frees caregivers from tedious tasks such as spreading the ingredient on the bread, cleaning up the preparation area, washing utensils and other dishes, etc. while allowing them to care for their charges (for instance, small children, elderly parents, elderly patients, the handicapped, etc.).

Embodiments, furthermore, provide apparatus adapted to dispense flowable foodstuffs from packages onto pieces of bread and/or similar foodstuffs. Some such apparatus can be used as home-kitchen appliances. Appliances of the current embodiment work by squeezing a flexible package, pouch, or bag of the foodstuff causing a seal in the package to open and allowing the foodstuff to be dispensed. Meanwhile, these appliances move the bread thereby causing the foodstuff to spread evenly across the bread. These appliances therefore improve the freshness of the foodstuff, improve portion control, improve neatness, cleanliness, tidiness, etc. of the preparation area, expedite preparation of sandwiches, etc. Embodiments also allow easier, more efficient transport of the foodstuff (in the packages).

Embodiments, moreover, provide soft-sided packaging for foodstuffs which allow the foodstuff to be dispensed by squeezing the side walls of the packaging. The applied pressure forces the product through an opening in the packaging. That opening can be created in a variety of manners. For instance, the package can be torn open and/or via a pre-fitted (or inserted) fitment and/or dispensing nozzle. These soft-sided packages (or bags in some embodiments) define holes from which they can hang in the sandwich making apparatus and which can serve to register the bags with the apparatus. In addition, or in the alternative, the bags can define secondary, bite-shaped registration features.

Various embodiments provide systems for making sandwiches. More specifically, the systems of these embodiments comprise a plurality of bags and a sandwich making apparatus adapted for use with one another. Each bag is adapted to contain a foodstuff that flows sufficiently to be spread by the apparatus of these systems. Moreover, the bags typically seal the foodstuff therein (until, if desired, un-sealed by the apparatus). As to the apparatus, each apparatus further comprises a tray, a press, and a drive. The tray holds a piece of bread while the press can press the bag of foodstuff to either unseal the bag and/or press the foodstuff out of the bag. Moreover, because the press (or some other feature of the apparatus) holds the bag in a fixed relation to the tray (or bread) in at least one direction, the press causes the foodstuff to flow on to the bread in the tray. The drive, meanwhile, operatively couples to the tray and the press to drive the press. It also, in the current embodiment, drives a relative motion between the press and the tray so that as the press presses the foodstuff out of the bag and it spreads it on the bread (in the tray).

In some embodiments the press further comprises a roller or even a pair of rollers. The apparatus can include a feature adapted to fix the position of the bag relative to the tray in at least one direction. Additionally, or in the alternative, the apparatus and/or bag can include corresponding registration features that allow the bag and apparatus to be registered in pre-determined locations/orientations with respect to one another. Those registration features can be bite-shaped.

Further still, some embodiments include a controller in which communicates with the drive to control the drive. For instance, the controller can cause the drive to drive either the tray, the press, or both to create the relative motion between the two. If desired, the bag and tray can be positioned with respect to each other such that they (and/or the bag and bread) are spaced apart vertically from one another. The press and/or bag can also be positioned and/or oriented relative to the tray and/or bread so as to form an oblique angle there between. A guard, if desired, can be provided to enclose a combination of the press, drive, and/or tray to some extent.

As noted above, some embodiments provide systems for making sandwiches which comprise various foodstuff bags and sandwich making apparatus. However, some embodiments provide foodstuff bags while other embodiments provide sandwich-making apparatus. Other embodiments provide various combinations of the two and/or methods for making sandwiches that can comprise using such bags, systems, apparatus, etc.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and/or nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates two food preparation areas and sandwich making apparatus.

FIG. 2 illustrates a sandwich making apparatus in a loaded configuration.

FIG. 3 illustrates a sandwich making apparatus in an unloaded configuration.

FIG. 4 illustrates a perspective view of a sandwich making apparatus with its covers removed.

FIG. 5 illustrates a cross-sectional view of the sandwich making apparatus of FIG. 4 as seen along line AA.

FIG. 6 illustrates a foodstuff package for use with sandwich making apparatus.

FIGS. 7A and 7B illustrate a dispensing mechanism for a sandwich making apparatus.

FIG. 8 illustrates a flowchart of a method for making sandwiches.

FIG. 9 illustrates a perspective view of a fitment for a foodstuff package.

FIG. 10 illustrates an end view of a fitment for a foodstuff package.

FIG. 11 illustrates a cross-sectional view of a fitment for a foodstuff package as seen along line BB of FIG. 6.

FIG. 12 illustrates a schematic diagram of a control system for a sandwich making apparatus.

### DETAILED DESCRIPTION

This document discloses systems, apparatus, methods, etc. for making sandwiches and, more particularly, sandwich making apparatus, bags for sandwich making apparatus, and related systems and methods.

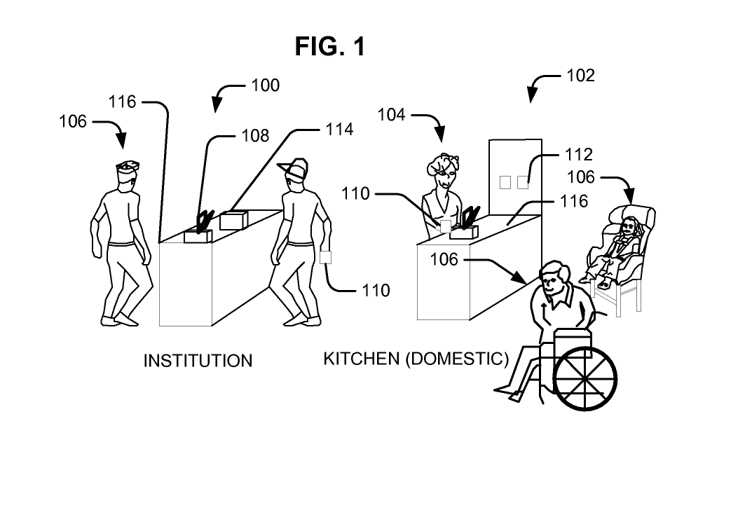

FIG. 1 illustrates food preparation areas and sandwich making apparatus. More specifically, FIG. 1 illustrates two food preparation (and/or service) areas 100 and 102, users 104 and 106, sandwich making apparatus 108, pieces of bread 110, foodstuff packages 112, a box 114 of foodstuff packages 112, and various counters 116, cutting boards, utensils, dishes, cabinets, refrigerators, stoves, ovens, toasters, toaster ovens, etc. (hereinafter and for the sake of convenience “counters”). The food preparation areas 100 and 102 can arise in a variety of different contexts including (but not limited to) domestic, institutional, and commercial contexts. In these food preparation areas 100 and/or 102, a user 104 (or users 104) typically prepares and/or serves snacks, meals, and (more generally) food for other users 106. The users 104 can be cooks, waiters/waitresses, bar tenders, chefs, nurses, interns, mothers, fathers, grandparents, caregivers, etc. The other users 106 can be a variety of difference types of people including (but not limited to) customers, patients, inmates, children, the elderly, handicapped individuals, etc. And, of course, particular users 104 and particular users 106 may change roles from time to time in non-limiting fashions.

Nonetheless and with continuing reference to FIG. 1 the users 104 prepare food for the other users 106 on certain occasions. In so doing, they often prepare sandwiches for the users 106 thereby dirtying the food preparation areas 100 and/or 102 as well as the counters 116 therein. Moreover, while sandwich making activities pre-occupy users 104, they cannot attend to other tasks, chores, and/or other activities. For instance, should a child user 106 begin crying, a parent user 104 would usually want to stop preparing a sandwich to attend to the child. And, of course, in high-volume situations, time taken to prepare a sandwich for a particular user 106 takes the attention of a user 104 that might otherwise be used serving other users 104. Thus, they might view preparing food (for instance, sandwiches) as a task that they would otherwise like to avoid or at least minimize. Sandwich making apparatus 108 of embodiments allows them to do so.

Thus, instead of taking a piece of bread 110 and spreading foodstuff on it manually, users 104 can use sandwiching making apparatus 108 to make sandwiches. More specifically, users 104 can place a piece of bread 110 in the sandwich making apparatus 108; place a foodstuff package 112 in the sandwich making apparatus 108; start the sandwich making apparatus 108; and receive (in return) a sandwich with the foodstuff spread on the piece of bread 110. They can therefore expend more of their efforts on activities other than preparing sandwiches. Moreover, the foodstuff packages 112 can be hung from various (vertical) surfaces in the preparation areas 100 and 102 and/or placed in, stored in, transported in, etc. various boxes 114 and/or other convenient and/or transportation enabling containers. Sandwich making machines and foodstuff packages of embodiments are available from IWICH, LLC of Austin, Tex.

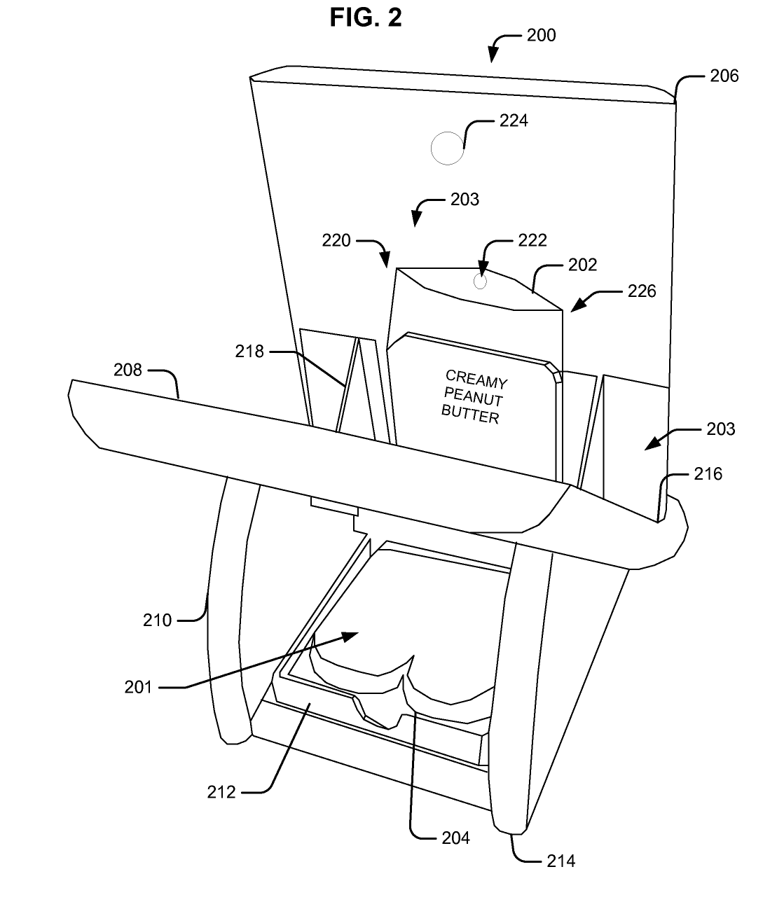

FIG. 2 illustrates a sandwich making apparatus in a loaded configuration. More specifically, FIG. 2 illustrates a sandwich making apparatus 200, a presentation area 201, a foodstuff package 202, a working area 203, a piece of bread 204, a cover 206, a guard 208, supports 210, a tray 212, a chassis 214, a hinge 216, guides 218, a registration feature 220, a hole 222, a latch 224, and a clamp area 226. In some embodiments, the sandwich making apparatus 200 accepts the foodstuff package 202 in between its cover 206 (shown open) and guard 208 and accepts the tray 212 (with the bread 204 in it) in the presentation area 201. The user then closes the cover 206 against the guard 208 and starts the apparatus which proceeds to spread the foodstuff in the foodstuff package 202 over the bread 204 and presents the resulting sandwich to the user in the presentation area 201.

Moreover, the sandwich making apparatus 200 of embodiments can be a home and/or kitchen appliance sized to sit on a counter and consume modest amounts of 120 VAC power (or some other form of power). It can comprise a controller such that its operation is largely automatic and so that it can repeat its operations. Of course, instead of being powered, apparatus of embodiments could be driven by a hand crank or some other manual drive with cams, linkage, etc. to approximate various operations disclosed herein. Note that, in certain situations, users might consider it more fun to operate such apparatus manually. Moreover, because the apparatus spreads the foodstuff on the bread 204 in a controlled manner, it makes little if any mess while it operates and can be made of materials suitable for wiping clean (and/or immersion in dishwashing water). It also can control the size of the portions of foodstuff dispensed onto the bread 204 and can be sized and dimensioned to accept a variety of breads 204, foodstuff packages 202, and/or various foodstuffs therein. For instance, it could be sized to handle ordinary sandwich bread, French bread, flat bread, muffins, pastries, etc.

With continuing reference to FIG. 2, the presentation area 201 can be an open area large enough for the tray 212 and bread 204 to be placed therein and extracted therefrom. It also represents a staging point for the bread 204 before it is withdrawn into the apparatus and an area at which the apparatus presents (at least partially) prepared sandwichs to the user. Moreover, because the foodstuff comes stored in the foodstuff packages 202 and is handled largely by the apparatus, the presentation area 201 remains generally clean with little or no foodstuff coming in contact with either the apparatus or the users hands, not to mention the counter 116 that it likely would have contacted in the preparation areas 100 and/or 102 (see FIG. 1) had conventional methods been used to prepare sandwiches.

Still with reference to FIG. 2, the foodstuff package 202 might merit some further disclosure. More specifically, the foodstuff package 202 can be a soft-sided package, bag, pouch, or similar object capable of storing a foodstuff, isolating/sealing it from the environment, and dispensing it as disclosed elsewhere herein. Some foodstuff packages 202 have one or more permanent seals and at least one seal which can be opened by a sandwich making apparatus 200. The foodstuff package 202 can be designed to correspond in shape and size to the guides 218 and other features of sandwich making apparatus 200 with which it can be used. For instance, foodstuff packages 202 of embodiments can include the registration feature 220 which mates with a corresponding registration feature of the apparatus. Additionally, or in the alternative, foodstuff packages 202 can include a hole 222 from which they can hang in the apparatus from a protrusion, lobe, lug, pin, etc. at an appropriate location. A clamp area 226 of many foodstuff packages 202 is adapted to be clamped by a clamp of the apparatus so that it is held in place in the apparatus during various operations. Moreover, some foodstuff packages 202 can be positioned in such apparatus, used to supply the foodstuff for a sandwich, and then disposed of afterward.

As to the bread 204, it can be any type of bread or bread-like material. It could be a piece of white bread, wheat bread, whole wheat bread, rye bread, French bread, sourdough bread, crackers, tortillas, pita bread, etc. with trays 212, presentation areas 201, and other features of the apparatus corresponding in size, shape, etc. The bread is placed in the tray 212 and rides therein into various sandwich making apparatus 200. It then rides back out of the apparatus on the tray 212 while being coated (or “spread”) with foodstuff from a foodstuff package 202. The spread bread 204 can be removed from the apparatus 200 and eaten as-is, folded over and eaten, topped with another piece of bread perhaps, prepared with additional ingredients, etc. (using the apparatus or not).

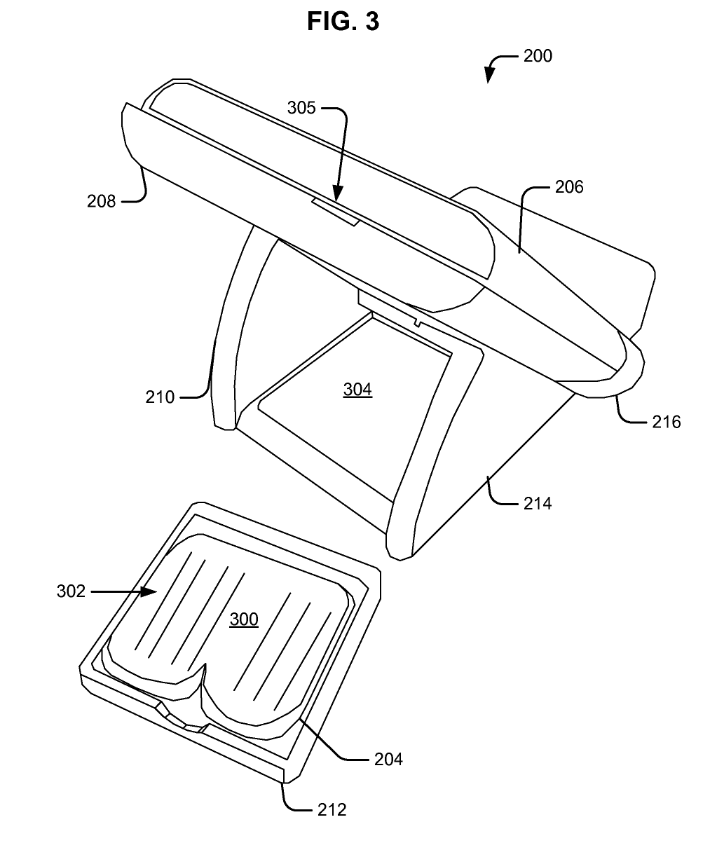

FIG. 2 also shows the cover 206. The cover 206 serves several purposes in the current embodiment. For instance, it can serve as a platen against which a roller (located in the guard 208, see FIG. 3) presses against the foodstuff package 202 to unseal the foodstuff package 202 and cause the foodstuff therein to dispense onto the bread 204. The cover 206 can also serve to prevent foreign objects from falling into or otherwise entering the working area 203 of the apparatus. Thus, the cover 206 can (partially) enclose the working area 203 and foodstuff package 202 and/or serve as a “sneeze guard.”

Meanwhile, the guard 208 can serve a variety of functions also. For instance, it can prevent users from making accidental contact with various moving parts of the apparatus. The guard 208 can help enclose the working area 203 and foodstuff package 202 if desired. It can also include, serve as, provide, etc. a sneeze guard to protect the presentation area and food and/or surfaces therein from inadvertent exposure to foreign materials. And, of course, the guard 208 can support the roller which presses the foodstuff packages 202. The support 210 of embodiments can, in turn, support the guard 208 and/or cover 206. Additionally, the supports 210 can be used to route various wires and other items to/from components in the guard 208. The chassis 214 and/or portions thereof cans serve such and/or similar functions as well as supporting the sandwich making apparatus 200 of embodiments.

With continuing reference to FIG. 2, the tray 212 can be shaped and sized to correspond to particular types of bread 204. Furthermore, it can be coupled to an actuator, drive, etc. which retracts it into various sandwich making apparatus 200 and/or extends it therefrom. Moreover, it can be coupled to, removably coupled to, and separate from the chassis 214 of various sandwich making apparatus 200. Some trays 212 can be made of materials compatible with hand washing, machine washing, other cleaning/sterilization techniques, microwaving, oven-produced heat, etc.

The hinge 216 illustrated by FIG. 2 couples the cover 206 to the guard 208. Moreover, the hinge of embodiments allows the cover 206 to pivot about it and thus close and open relative to the guard 208. Meanwhile, the guides 218 help users coarsely position the food packages 202 in the apparatus while the hole 222 (and corresponding hook on the cover 206) and registration features 220 maintain the food package 202 in its intended position relative to the cover 206 and guard 208 (including limiting its relative rotational movement with respect thereto) even while the cover 206 pivots relative to the guard 208.

Still with reference to FIG. 3, the latch 224 can mate with a corresponding feature on the guard 208 to releasably latch the two together. Moreover, it can be instrumented to allow a controller to determine whether the cover 206 is in its closed position or opened position. It can be any type of latch 224 including those which work on mechanical principles (for instance, a ball and detent), magnetic properties, electromagnetic properties, etc.

The clamp area 226 of various foodstuff packages 202 may be spaced apart from areas of the foodstuff package 202 which contain the foodstuff. Moreover, it can be located near/adjacent to the registration feature 220 and or hole 222. When clamped by the clamp area 226, the foodstuff package 202 can be held in a relatively fixed position with respect to the cover 206, guard 208, a press(es) therein, etc.

FIG. 3 illustrates a sandwich making apparatus in an unloaded configuration. More specifically, FIG. 3 illustrates the sandwich making apparatus 200 with the cover 206 closed and a piece of bread 204 with foodstuff 302 spread in rows 302 on it. The tray 212 is shown removed from the presentation area 201. In operation, a user could have placed a piece of bread 204 in the tray 212 and placed the tray on a slide plate 304 of the sandwich making apparatus 200. They could also have placed a foodstuff package 202 in the cover/guard 206/208, closed the cover 206, and started the sandwich making apparatus 200 of the current embodiment. The sandwich making apparatus 200 would have spread the foodstuff 300 on the bread 204 in the rows 302 and presented the resulting prepared bread/foodstuff combination in the tray 212 on the slide plate 304.

In the current embodiment, the sandwich making apparatus 200 operates as follows. With the foodstuff package 202 loaded, the cover 206 closed, and the bread 204 in the tray 212, the user could have the sandwich made by pushing a start or on/off button 305 in FIG. 3 of the apparatus to indicate to its controller to begin making a sandwich. As is disclosed further herein, the apparatus could then drive the tray 212 toward the proximal end of the slide plate 304 while unsealing the foodstuff package 202, dispensing the foodstuff 300 from the foodstuff package 202, and spreading the dispensed/dispensing foodstuff 300 over the bread 204 as it moves out from under the cover/guard 206/208.

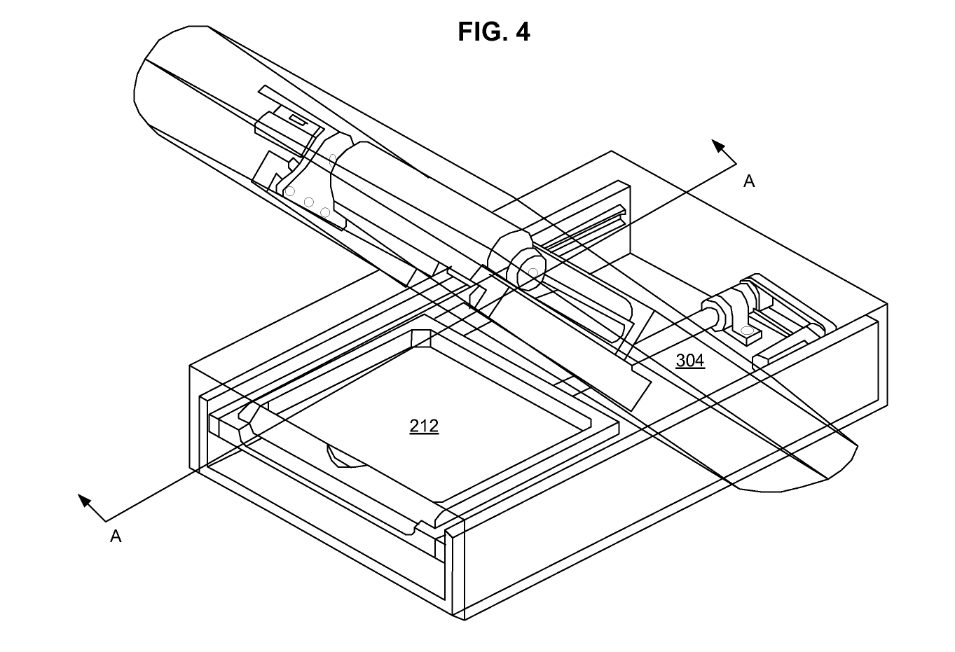

FIG. 4 illustrates a perspective view of a sandwich making apparatus with its covers removed. More specifically, FIG. 4 illustrates a sandwich making apparatus 400, a channel 402, an actuator 404, a drive belt 406, a motor 408, a driver (gear) 410, a follower (gear) 412, lands 414, a carriage 415, a roller 416, a pillow block 418, a pair of racks 420, a pair of pinion (gears) 422, a motor 424, and a stop 426. The sandwich making apparatus 400 of various embodiments can include a chassis housing the channel 402 (and/or various other components), a guard and cover. However, for the sake if clarity these components of the current embodiment have been omitted/rendered as “wireframes” in FIG. 4.

As FIG. 4 illustrates, the sandwich making apparatus 400 of the current embodiment rests on the channel 402. The channel 402 also provides the lands 414 on which the tray 212 can ride. Moreover, the channel 402 defines the slide plate 304 over which the tray 212 slides and/or traverses (whether in contact therewith or not). The channel 402 of the current embodiment also provides a convenient place to mount the actuator 404, the motor 408, and the driver 410 and follower 412.

The actuator 404 is operatively coupled to the tray 212 and drives the tray 212 between its extended and retracted positions at/near, respectively, the proximal and distal ends of the channel 402. Moreover, the actuator 404 can be a telescoping arm, a worm screw, etc. It is driven by a combination of the motor 408 driving the driver 410 which drives the drive belt 406. The drive belt 406 drives the follower 412 which drives the actuator 404. Of course, the motor 408 of the current embodiment (and the other drive train components 406, 408, 410, and/or 412) can run in both directions and/or at various speeds to move the tray 212.

FIG. 4 also illustrates the carriage 415 and related components. For instance, the roller 416 operatively couples to a pair of pinions 422 (one on each end of the roller 416). The roller 416 of the current embodiment also operatively couples to the motor 424 (near its distal end) through the pillow block 418. The pinions 422 in turn rest on and/or engage corresponding racks 420 on either side of the carriage 415. The motor 424 therefore drives the roller 416 along the racks 420. Moreover, as it rolls, the roller 416 presses (a foodstuff package 202) against the inside of the cover 206 (see FIGS. 2 and 3) when the cover 206 is in its closed position.

Thus, with a food stuff package 202 positioned between the cover 206 and guard 208 (and, thus, the roller 416), the roller 416 presses against and squeezes the foodstuff package 202. Furthermore, the roller 416 can be controlled so that it nominally resides at the proximal (and/or upper) end of the racks 420. It can then roll along the racks 420 squeezing the foodstuff package 202 as it progresses. As is disclosed elsewhere herein, the foodstuff package 202 can be configured to work in conjunction with the roller 416 and cover 206 (acting as a platen) to dispense the foodstuff 300 onto the bread 204.

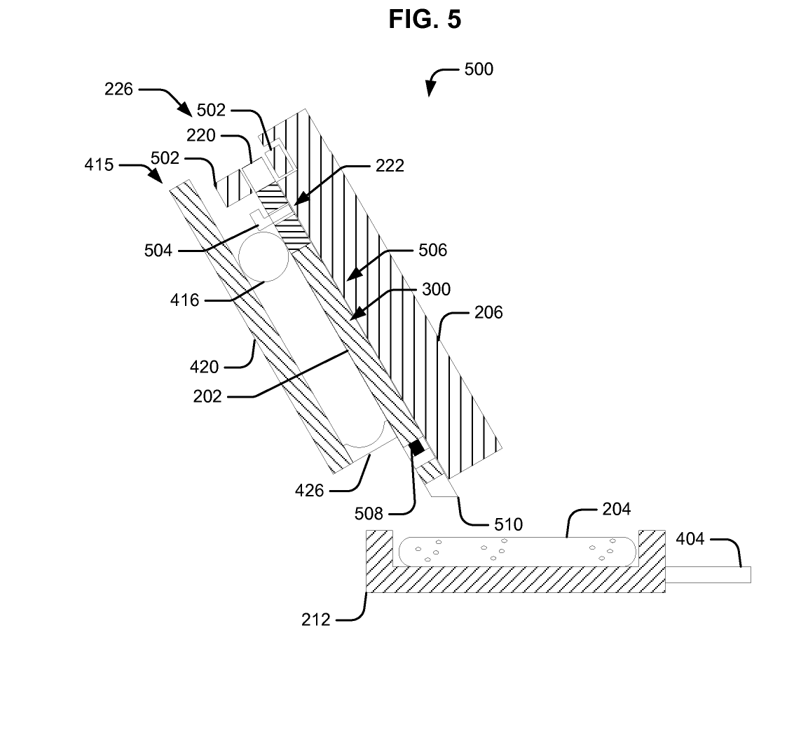

FIG. 5 illustrates a cross-sectional view of the sandwich making apparatus of FIG. 4 as seen along line AA. In addition to other features of the current embodiment, FIG. 5 illustrates a sandwich making apparatus 500, a clamp 502, a hook 504, a foodstuff volume 506, a temporary seal 508, and a dispense nozzle 510. More generally, FIG. 5 illustrates a foodstuff package 202 in a sandwich making apparatus 500 of embodiments. The foodstuff package 202 is generally positioned between the guard 208 (not shown) and the cover 206. At or near its proximal end, the clamp 502 holds the foodstuff package 202 in place by its clamp area 226 despite forces that might be imparted on it by the rollers 416 and/or other components, gravity, etc. The clamp 502 can be split with one half on the cover 206 and the other half on the guard 208 or it can be on one or the other of these components. Moreover, any type of clamp 502 can be used without limiting the current disclosure.

Additionally, the registration feature 220 (shown in cross section) at or near the proximal end of the foodstuff package 220 in the current embodiment mates with a corresponding feature on the cover 206 (and/or guard 208). These registration features can assist in ensuring that the foodstuff package 202 is held in place (and/or orientation) relative to the bread 204 (or tray 212) and the roller 416. Additionally, or in the alternative, the hook 504 and/or hole 222 can provide guidance in placing/orientating the foodstuff package 202 as well as supporting the foodstuff package 202 on the cover 206 while the cover 206 is in its opened position.

Toward the longitudinal center of the foodstuff package 202 of the current embodiment, the foodstuff volume 506 holds a select amount (and/or type) of foodstuff 300. Moreover, that foodstuff volume 506 can seal the foodstuff 300 in a clean, sterile, etc. environment. The foodstuff volume 506, furthermore, lays adjacent to the temporary seal 508 of the foodstuff package 202 and is in fluid communication with it. The temporary seal 508 can be formed be heating the panels of the foodstuff package at the corresponding locations while they are pressed together. The heated areas, according to the current embodiment, will thus fuse together in a manner which allows internal pressure of about 5-10 psi (or some other pressure range) to force the fused areas apart, break them, or otherwise open the temporary seal 508.

Toward the distal end of the foodstuff package, FIG. 5 illustrates the dispense nozzle 510. It is in fluid communication with the discharge side of the temporary seal 508 so that foodstuff flowing from the temporary seal 508 can reach the dispense nozzle 510. It can be positioned, shaped, dimensioned, etc. to direct the foodstuff 300 flowing through it (from the temporary seal 508) toward the bread 204 and/or tray 212. For instance, when the foodstuff package 202 is in the apparatus, the dispense nozzle 510 can be positioned above the bread 204 or tray 212 by about ½ inch or so depending on user desires.

Thus, foodstuff packages 202 can be configured with a sealed foodstuff volume 506 holding the foodstuff 300, an inner and temporary seal 508, and a dispense nozzle 510. As the roller 416 traverses the racks 420 from its initial position (at or near the proximal end of the foodstuff package 202) toward the distal end of the racks 420, it encounters the proximal end of the foodstuff volume 506. The resulting pressure in that volume imparted by the roller 416 and cover 206 pressurize the foodstuff volume 506 causing the temporary seal 508 of the package to open. The pressurized foodstuff 300 therefore flows through the open, temporary seal 508 and out through the dispense nozzle 510. Moreover, because the dispense nozzle 510 can be positioned on or near the bread 204, the foodstuff 300 can flow onto the bread 204. More specifically, in some embodiments, the dispense nozzle 510 of the foodstuff package 202 can be held in a position about ½″ above the bread 204.

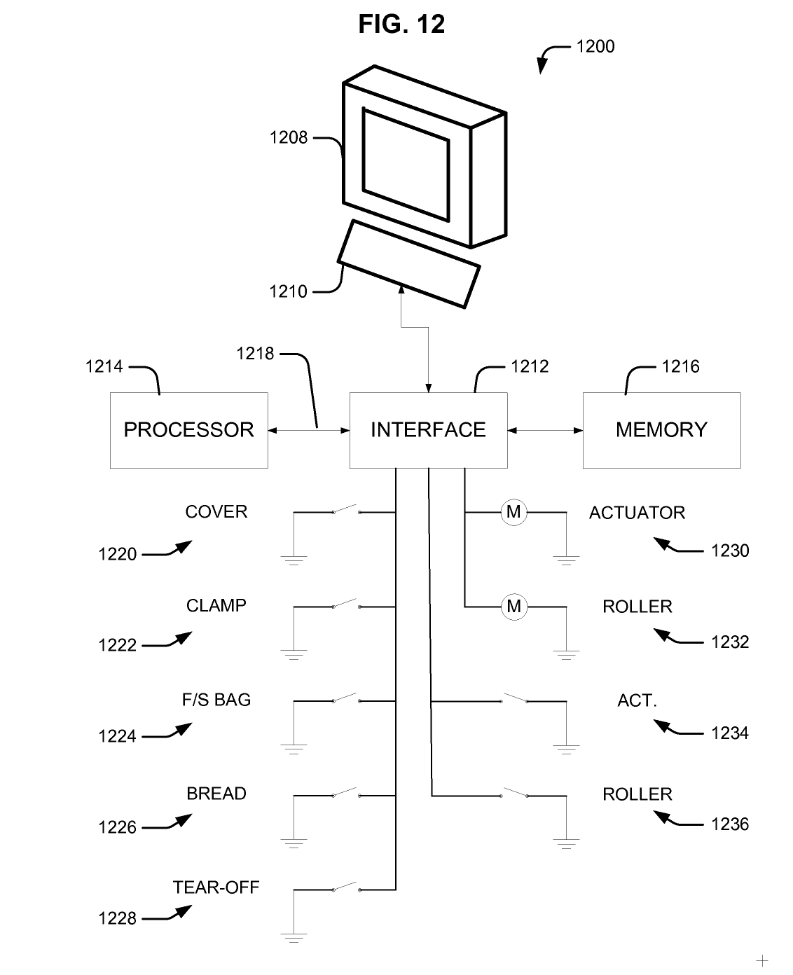

Meanwhile, a controller (see FIG. 12) can control the motion of both motors 408 and 424 so that the bread 204 moves pass the dispense nozzle 510 of the foodstuff package 202 as the foodstuff 300 is flowing from the dispense nozzle 510. The dimensions, shapes, locations, etc. of the various moving components (the actuator 404, the roller 416, the pinions 422, etc.) can be selected so that the foodstuff 300 spreads across the piece of bread 204 more or less uniformly without flowing onto the tray 212, the slide plate 304, etc.

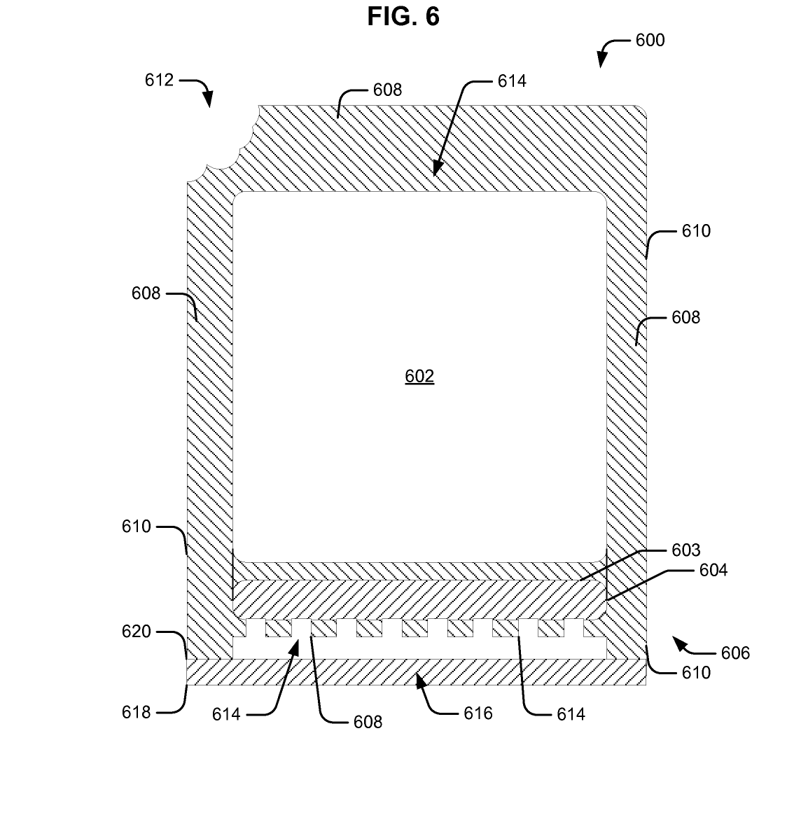

FIG. 6 illustrates a foodstuff package for use with sandwich making apparatus. More specifically, FIG. 6 illustrates a foodstuff bag 600, a foodstuff volume 602, a temporary seal 603, a nozzle plenum 604, a dispense nozzle 606, a permanent seal 608, a registration mark 610, channels 614, a dispense plenum 616, a tear off strip 618, and a perforation 620. The foodstuff bag 600 of the current embodiment is manufactured from polypropylene film available from PacTech Packaging of Rochester, N.Y. This type of film has the ability to form both permanent seals and temporary seals between two plies of the film by the application of one combination of pressure and temperature to some areas and another combination to other areas. Herein, the “permanent” seals are those which can be expected (under normal conditions, handling, circumstances, environments, etc.) not to separate or otherwise form leak paths in the space between the various plies of the foodstuff bag 600. “Temporary” seals, however, are configured to form leak and/or flow paths in the space between those plies when exposed to the pressure imparted to the foodstuff volume (and/or by other user-selected normal conditions)

These abilities of the film allow the formation of various features of foodstuff bags 600 of the current embodiment. For instance, an area defined by the permanent seal(s) 608 runs around the periphery of the foodstuff bag 600 and includes the areas between the various channels 614. In some embodiments, the temporary seals 603 open at approximately 5 psi. While the permanent seals 608 remain intact at internal pressures up to about 200 psi. The remainder of the foodstuff bag 600 of the current embodiment can be open having not been sealed either temporarily or permanently.

Those remaining open areas include the foodstuff volume 602. That void can be sized and shaped to hold a selected quantity of some selected foodstuff 300. It can be more or less centrally located in the foodstuff bag 600 although it need not be. In many embodiments, the foodstuff volume 602 represents the bulk of the area of the foodstuff bag 600. Moreover, the foodstuff volume 600 is in fluid communication with the temporary seal 603 which lies across the width of the foodstuff bag 600 (excepting the permanent seals 608 at either side thereof). Thus, the temporary seal 603, when it opens, allows the foodstuff 300 to flow from the foodstuff volume 602 (across the width of the foodstuff bag 600) at the opened temporary seal 603.

Another open area, the nozzle plenum 604 lies downstream of the temporary seal 603 and is in fluid communication with it. The nozzle plenum 604 allows the incoming foodstuff 300 from the foodstuff volume 602 to spread out thereby reaching each of the, or some select, channels 614 of the dispense nozzle 606. Thus, the channels 614 of the current embodiment receive relatively uniform amounts of the flowing foodstuff 300. The foodstuff 300, still being urged on by the pressure being caused by the roller 416, flows through the channels 614 into the dispense plenum 616. Note that the size, shape, length, etc. of the channels 614 can be selected in accordance with the properties of the foodstuff 300 selected for the foodstuff bag 600. The dispense plenum 616 can allow enough residence time/distance for the flowing foodstuff 300 to assume a uniform cross-section before it exits the dispense nozzle 606. However, in embodiments, that residence time/distance is chosen to produce the rows 302 of the foodstuff illustrated by FIG. 3.

With continuing reference to FIG. 6, the perforation 620 or other intentionally weakened area between the tear off strip 618 and the remainder of the bag can allow users to tear the tear off strip 618 thereby exposing (the otherwise protected, clean, sterile dispense nozzle 606). Thus, the dispense nozzle 606 can remain clean until the foodstuff bag 202 is dispensed. It can also remain spaced apart from other components of the apparatus until removed therefrom thereby enhancing/preserving sanitary conditions of the sandwich making apparatus of embodiments.

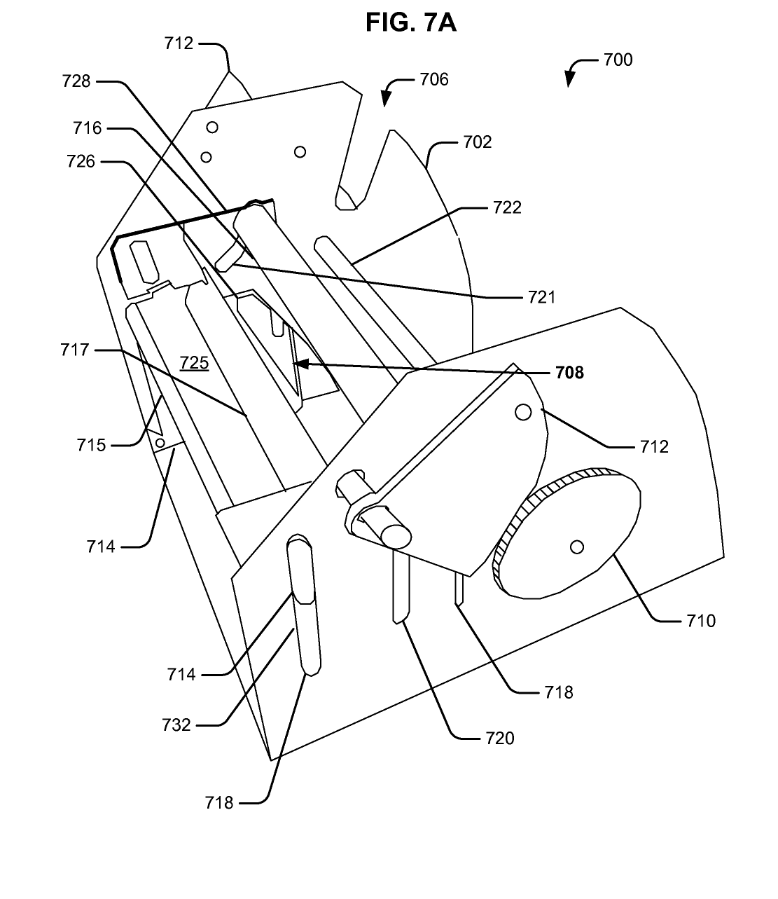

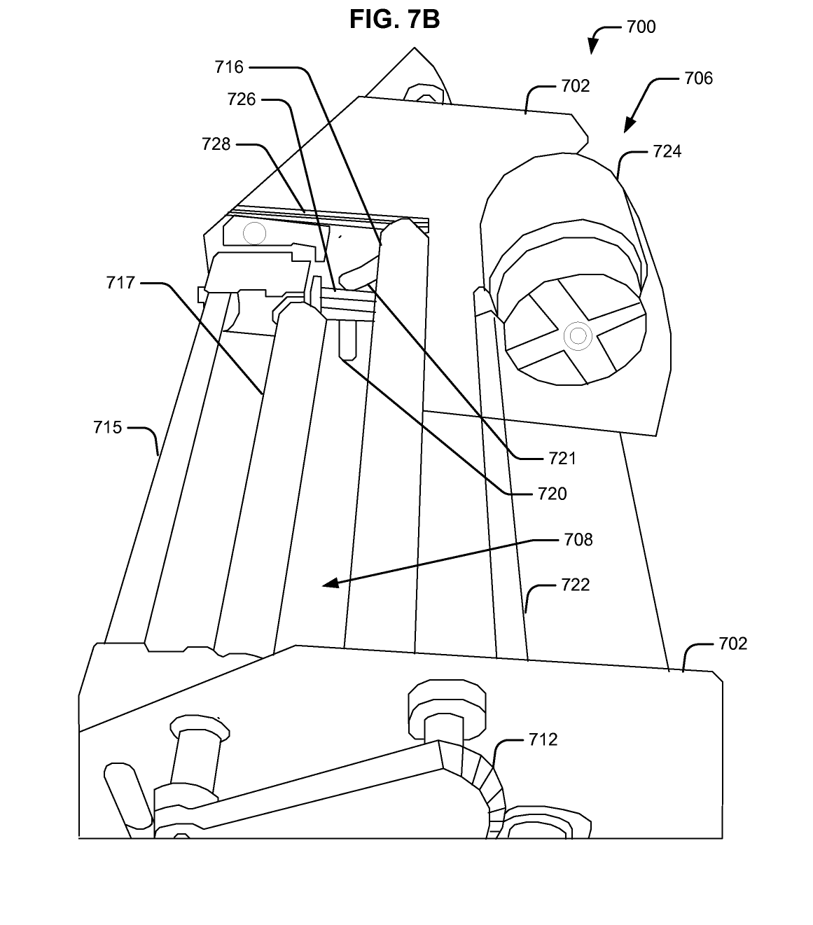

FIGS. 7A and 7B illustrate a dispensing mechanism for a sandwich making apparatus. More specifically, FIGS. 7A and 7B illustrate a chassis 700, a guide plate 702, a motor slot 706, a bag aperture 708, drivers 710, followers 712, bushings 714, a carriage 715, rollers 716 and 717, carriage guides 718, driven roller guides 720 and 721, an axle 722, a motor 724, a carriage surface 726, and carriage lifts 728. Taken together these components form a mechanism of embodiments for dispensing foodstuff from packages. Generally, in operation, the driven roller 716 translates toward the passive roller 717 and together they press the foodstuff bag 600 held there between in the bag aperture 708. The carriage 715 (and passive roller 717) of the current embodiment then begins translating along the foodstuff bag 600 in tandem with the driven roller 716 pressing the foodstuff bag 202 and causing foodstuff 300 to be dispensed there from.

At this juncture, it might be beneficial to consider some of the foregoing components in more detail before discussing how the mechanism operates. Note that many of the foregoing components are present in the current embodiment in pairs although FIGS. 7A and 7B do not show all of them. Continuing now with disclosure of the various components, the chassis 700 provides structure on which the other components rest, are coupled, are operationally coupled, etc. Indeed, it defines the guide plates 702, the motor slot 706, and the carriage guide 718, and the driven roller guide 720 (the latter two being formed in the guide plates 702 of the chassis 700). The motor slot 706 provides a location for the motor 724 to be mounted and/or clamped to the guide plate 702. Its location can be selected so that the motor 724 engages and/or drives the driver 710 when the chassis is assembled and in operation.

Among other functions, the carriage 715 carries the passive roller 717. The carriage guides 718 (working with a projection of the bushing 714) mated therein define the path of the carriage 717 and, therefore, the path of the passive roller 717. Moreover, as is disclosed further herein, the top surface 725 of the carriage 715 interacts with the driven roller 716 to cause the carriage 715 to return along the foodstuff bag 600. A portion of the carriage 715, furthermore, also interacts with the driven roller 716 to cause the passive roller 717 to translate back along the foodstuff bag 600. The bag aperture 708 is formed in the top surface of the carriage 715. Its size and location are chosen so that a foodstuff bag 600 or package can be suspended between the rollers 716 and 717 and so that those rollers 716 and 717 can translate along the foodstuff bag 600 while pressing it.

With continuing reference to FIGS. 7A and 7B, a pair of bushings 714 are located between the ends of the carriage 715 and the guide plates 702 to maintain the carriage 715 in its position in the chassis 700. Moreover a projection 732 of each of the bushings 714 can mate with and slidably interact with the guide plate 702 via carriage guide 718. In some embodiments, the bushing 714 is Teflon so that its surface allows the carriage 715 to travel freely and/or with minimal friction.

Meanwhile, the carriage 715 operatively couples with the passive roller 717 via bearings so that the passive roller 717 can rotate as it translates along the foodstuff bag 600. The carriage 715 can also, define, include, etc. a pair of end frames 730. These end frames 730, furthermore, define the driven roller guide 721 through which the driven roller 716 can translate relative to the carriage 715. However, the carriage surface 726 and/or a portion of the end frame catches the driven roller 716 as it traverses the foodstuff bag 600 in the direction toward its distal position. Likewise, the carriage lift 728 of the end frames 730 are positioned and configured to catch the driven roller 716 as it returns along the (emptied) foodstuff bag 600. The carriage surface 726 and carriage lift 728 are spaced apart by a distance sufficient to allow the driven roller 716 to translate away from/toward the foodstuff bag 600.

Regarding the rollers, the driven roller 716 and passive roller 717 can be made of material durable enough to press many foodstuff bags 600. Moreover, while the passive roller 717 translates with the carriage 715, the driven roller 716 translates toward the passive roller 717 (and foodstuff bag 600) and then (along with the passive roller 717) translates along the foodstuff bag 600. The driven roller 716 returns along that same path in many embodiments.

The motor 724 provides the motive power to move the driven and passive rollers 716 and 717 and/or carriage 415. Moreover, the motor 724 is operatively coupled to the drivers 710 to turn them. Note that, in some embodiments, the two drivers 710 (on either side of the chassis 700) are operatively coupled via the axle 722 so as to provide force on either side of the rollers 716 and 717 to drive them evenly along the foodstuff bag 600. In turn, the drivers 710 (which can be circular gears) drive the followers 712. The followers 712 could be circular gears too. However, for envelope, weight, etc. considerations, the followers 712 of the current embodiment are pie-shaped.

Further still, and with ongoing reference to FIGS. 7A and 7B, the followers 712 can interact with the driven rollers 716 through mechanical linkage (not shown) located in between the followers 712 and the guide plates 702. These linkages (as urged by the followers 712) cause the driven roller 716 to translate along the driven roller guides 720 and 721. In the alternative, or in addition, these components can be designed to cooperate without intervening linkage.

As noted elsewhere herein, the chassis 700 and/or guide plates 702 define the carriage guide 718 and the driven roller guide 720. However, the end frames 730 of the carriage 715 define the driven roller guide 721. The two driven roller guides 720 and 721 are shaped and positioned on, respectively, the guide plates 702 and the carriage 715 end frames 730 so that the driven roller 716 (following both driven roller guides 720 and 721) traverses from a position spaced apart from the passive roller 717 toward it and then into close proximity therewith. The spatial relationship of the two differing driven roller guides 720 and 721 (along with that of the carriage surface 726 and carriage lift 728) is such that when the driven roller 716 reaches the passive roller 717, the driven roller 716 contacts the carriage surface 726 and begins urging the carrier 715 along the carrier guide. The driven roller 716 then continues along the driven roller guide 720 in the guide plate 720 while urging the carrier 715 and passive roller 717 along the carriage guide 718.

When the driven roller 716 reaches the distal end of the driven roller guide 720 in the guide plate 702, the motor 724 can be programmed to stop and/or reverse its direction. Thus, the driven roller 716 can begin traversing back along the driven roller guide 720 and/or the emptied foodstuff bag 600. Moreover, because the carriage guide 718 and the driven roller guide 720 (in the guide plates 702) can be located and/or configured to cooperate, the driven roller 716 can, thus, begin urging the carriage 715 (and passive roller 717) along the carriage guide 718 and/or emptied foodstuff bag 600. When the carriage 715 reaches the proximal end of its carriage guide 718, it can stop while allowing the driven roller 716 to continue along its driven roller guides 720 and 721 in (respectively) the guide plates 702 and the end frames 730 of the carriage 715.

Thus, as FIGS. 7A and 7B illustrate, the motor 724 can urge the driven roller 716 toward the passive roller 717 thereby capturing and pressing foodstuff bags 600 there between. The motor 724 can then urge the rollers 716 and 717 along the foodstuff bag 600 before stopping them at the distal end of the stroke of the dispense mechanism. The motor 724 can then urge the rollers 716 and 717 back along its stroke and/or the foodstuff bag 600 captured between the rollers. When the rollers 716 and 717 reach the proximal end of the foodstuff bag 600, the motor 724 can urge the driven roller 716 away from the foodstuff bag 600 while allowing the passive roller 717 to remain relatively stationary with respect to the same.

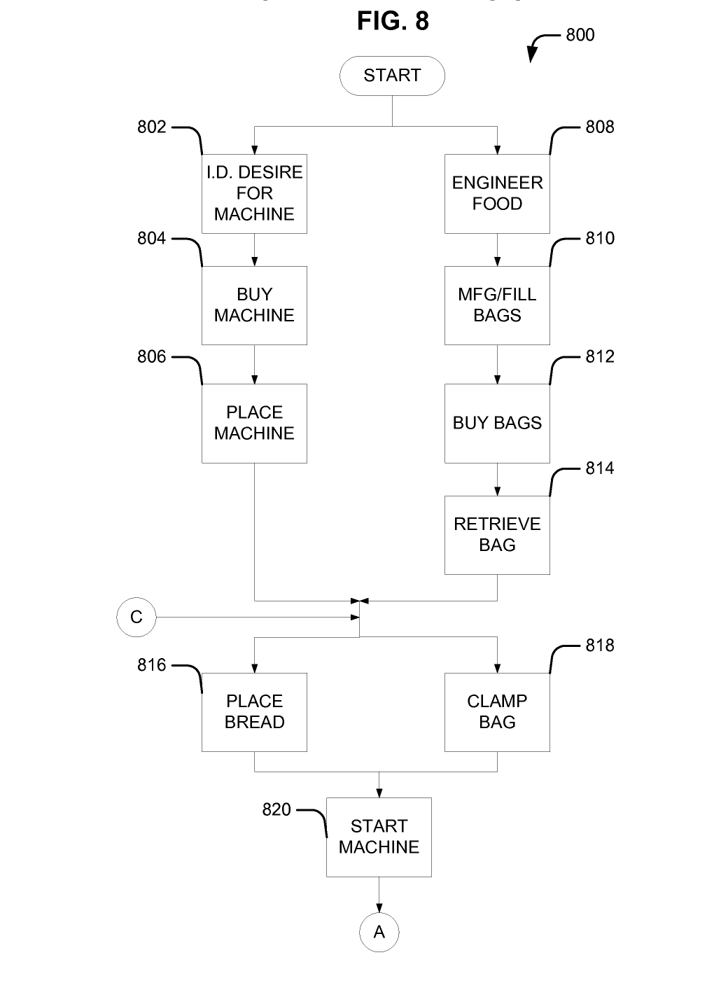

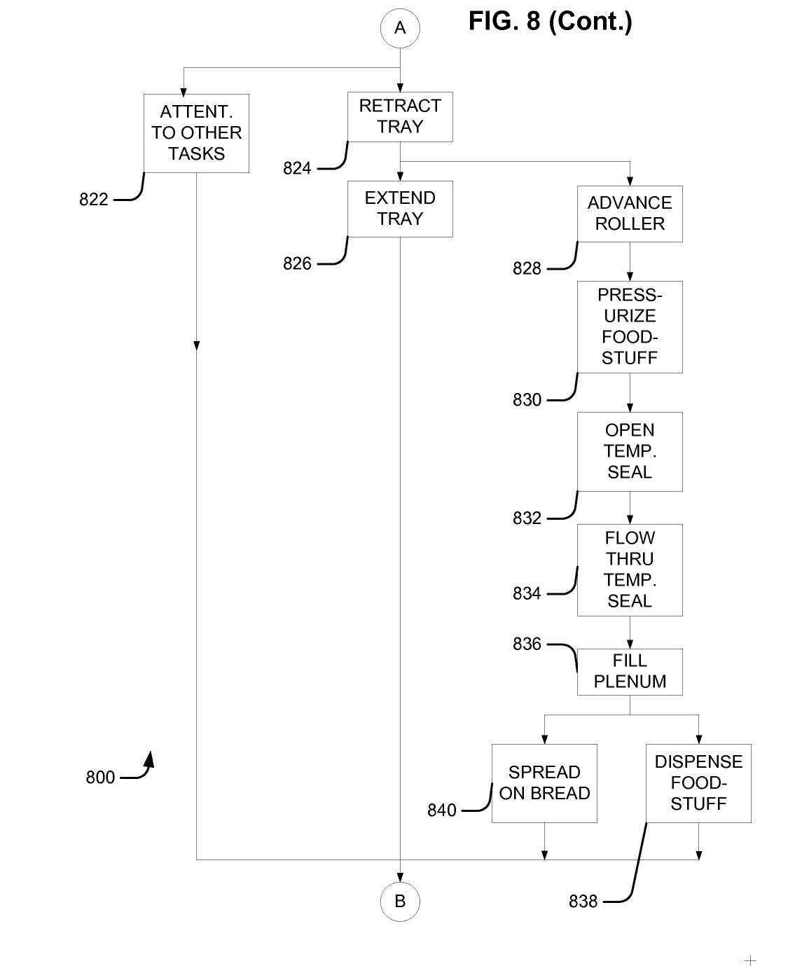

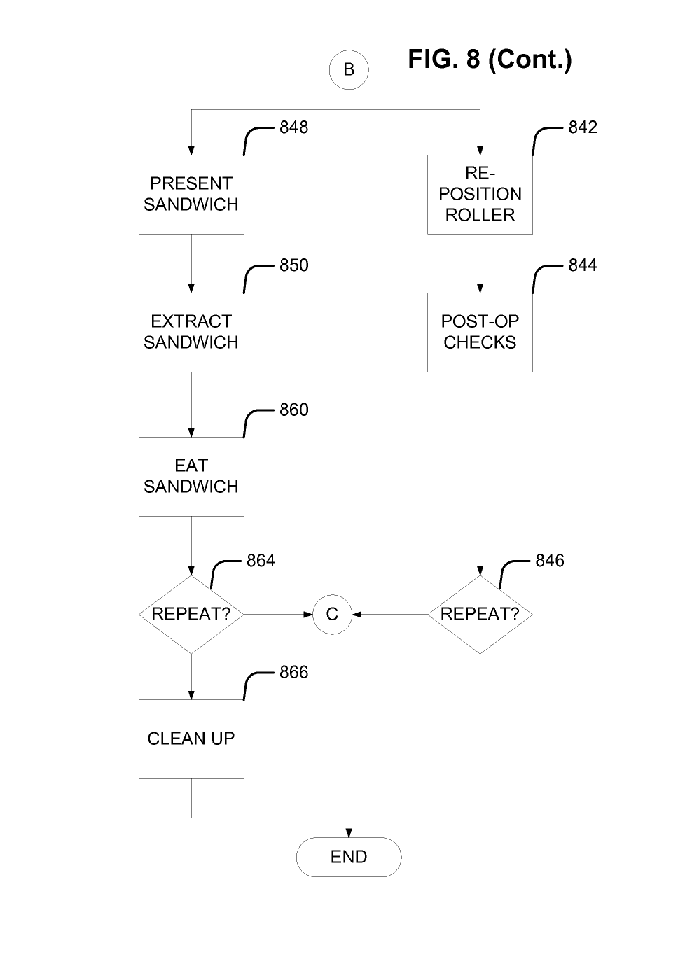

FIG. 8 illustrates a flowchart of a method for making sandwiches. More specifically, the method 800 includes various operations such as identifying a desire for a sandwich making apparatus. See reference 802. Often times, caregivers, food preparation workers, and the like, find themselves busy with several tasks at one time. One of these tasks might involve preparing food for others (and/or themselves) to eat. While they are busy preparing the food, they can not always adequately attend to their other duties such as watching children. Accordingly, they might feel a desire to have a system, apparatus, machine, etc. take care of at least a part of some of their tasks. Sandwich making apparatus of embodiments can satisfy that desire by preparing (at least partially) sandwiches thereby alleviating the user of certain tasks.

Thus, these users might buy a sandwich making apparatus (for instance, sandwich making apparatus 200 illustrated by FIG. 2). See reference 804. They might also place it in a convenient location near where they perform some/all of their tasks. For instance, a caregiver could place the apparatus on a counter 116 in a kitchen (see FIG. 1). This is possible in part because the sandwich making apparatus 200 of the current embodiment is compact enough to fit on typical kitchen counters in spite of overhanging cabinets, other appliances, etc. Moreover, such devices can be constructed to draw no more than the power typically available from domestic electrical outlets. See reference 806.

In accordance with the current embodiment, method 800 can continue as foodstuff is manufactured for use with sandwich making apparatus 100 and/or with foodstuff bags 600 and/or packages 112 (see FIGS. 6 and 1 respectively). Those foodstuffs 300 can be “engineered” to function with one or more foodstuff bags 600 or more specifically with the channels 614 thereof. For instance, the channels 614 can have an effective diameter, cross-sectional area, length, and/or other dimensions and shapes while the foodstuffs 300 possess physical properties allowing them to flow through the channels 614 without undue obstruction. For instance, the foodstuff 300 can be processed so that its viscosity, consistency, maximum particle size, self-adhesion, etc. allows it to flow under the roller-induced pressure in the package through the channels 614. In other words, those foodstuffs 300 can be engineered to work with the foodstuff bags 600 of the current embodiment. See reference 808.

Furthermore, those foodstuff bags 600 can be filled with compatible foodstuff 300 and can be made available for purchase. See reference 810. With continuing reference to FIG. 8, the user can then buy various foodstuff bags 600. Since the foodstuff bags 600 and foodstuffs 300 can be designed together, many different types of foodstuffs 300 can be made available in the foodstuff bags 600. Accordingly, users can obtain foodstuffs 300 for a variety of sandwiches as illustrated at reference 812.

When they are ready to have a sandwich made, the users can retrieve one or more foodstuff bags with their selected foodstuffs 300 stored securely therein. See reference 814. The users can also place a piece of bread 204 in a tray 212 and place the tray 212 in the presentation area 201. Moreover, if the tray 212 removably attaches to the actuator 404 (see FIG. 4) then the user can attach the tray 212 to the actuator 404. For instance, the tray 212/actuator 404 sub-assembly might include some type of detent, bayonet, ball/socket coupling mechanism so that the tray 212 can be removed for cleaning, inspection, replacement, etc. Thus, the user can place a piece of bread 204 in the sandwich making apparatus 200. See reference 816.

With ongoing reference to FIG. 8, the user can also place a foodstuff bag 600 in the working area 203 of the apparatus. That activity can include using the guides 218 to guide the foodstuff bag 600 on to the hook 504 (see FIG. 5). In the meantime, the registration marks 610 on the foodstuff bag 600 and cover 206 can be used to position and orient the foodstuff bag 600 at its intended position. Moreover, the user can clamp the foodstuff bag 600 in place in the sandwich making apparatus 200 as indicated at reference 818.

Furthermore, the user can close the cover 206 and/or start the apparatus. Depending on the embodiment, the apparatus might perform pre-operation checks. For instance, a controller of the apparatus could verify that appropriate sensors indicate that the cover 206 is closed; that the clamp 502 is clamped, that a foodstuff bag 600 and piece of bread 204 are positioned correctly, that the tear-off strip 618 has been removed, etc. See reference 820.

If the apparatus passes the pre-op checks, the sandwich making apparatus can begin making a sandwich (or portion thereof). For instance, the controller can cause the actuator 404 to retract the tray 212 into the apparatus. As it does so, the bread 204 in the tray 212 of course moves with it until the tray 212 either reaches a “stop,” the range of the actuator 404, or the controller stops the retraction. In many cases, though, the bread 204 will therefore be positioned under the dispense nozzle 510 of the foodstuff bag 600 and/or toward the distal side of the bread 204. The sandwich making apparatus 200 can, thus, be ready to dispense the foodstuff 300 and/or spread it onto the bread 204. See reference 824.

As method 800 continues in accordance with the current embodiment, the controller can begin advancing the roller 416 as shown at reference 828. Initially, the roller 416 can be positioned at or near the proximal (or in some cases upper) end of the foodstuff bag 600. Thus, it can begin moving in a distal direction and can encounter the proximal end of the foodstuff volume 602. As it presses the edge of the foodstuff volume 602, the foodstuff 300 therein becomes pressurized and exerts pressure/force on the temporary seal 603. See reference 830. The pressure eventually opens the temporary seal 603 by separating the two plies of the foodstuff bag 600 of embodiments from one another in the area of the temporary seal (see reference 832). As a result, the foodstuff 300 flows through the area defined by the temporary seal 803 and into the nozzle plenum 604. Moreover, the controller can pause the advance of the roller 416 to allow sufficient time for the foodstuff 300 to fill the nozzle plenum 604 as indicated at reference 834. This pause can assist in ensuring that all of the channels 614 will have foodstuff 300 available to them once the roller 416 begins advancing again. It can also reduce the possibility that foodstuff 300 might splatter in the apparatus. See reference 836.

Once the roller 416 of the current embodiment begins advancing again, foodstuff 300 will usually flow from the foodstuff volume 602, through the temporary seal 603 area (hereinafter, the “temporary seal”), the nozzle plenum 604, and then through the channels 614 of the dispense nozzle 606. For embodiments not having a dispense plenum 616, the foodstuff 300 then exits the foodstuff bag 600 and is either applied directly to the bread 204 and/or traverses some distance to encounter the bread 204. For instance, the foodstuff 300 could fall from the dispense nozzle 606 to the bread 204 thereby being spread in rows across the bread 204. For other embodiments, the foodstuff 300 flows from the channels 616 and into the dispense plenum 616 where it begins spreading (in a direction perpendicular to its longitudinal movement). Thus, the rows of foodstuff 300 will tend to blend together for such embodiments. These blended rows of foodstuff 300 can lend the spread foodstuff 300 an undulating appearance that (for some users) is aesthetically pleasing. See reference 838 and 840.

Of course, in the meantime, the user could have been attending to other matters. For instance, a mother could have been caring for, playing with, etc. her children or a food preparer could have been serving customers. See reference 841. Of course, as the sandwich making apparatus 200 has been spreading the foodstuff on the bread 204, it has also been moving the tray 212 (with the bread on it) passed the dispense nozzle 610 and toward the presentation area 201. Thus, the actuator 404 extends the tray 212 into the presentation area 201 and presents the sandwich to the user as shown at reference 848.

In the meantime, the user can prepare the sandwich making apparatus for another cycle. For instance, the roller 416 can be re-positioned near the location where the proximal end of the next foodstuff bag 600 will be (when inserted in the apparatus). See reference 842. Several post-op checks can also be performed as illustrated by reference 846. For instance, the operation/integrity of the various sensors can be confirmed by the controller and/or the controller can determine when/if the empty foodstuff bag 600 has been removed from the apparatus before indicating that the sandwich making apparatus 200 is ready for another cycle.

While the controller is performing post-processing activities, the user can extract the sandwich from the tray 212 per reference 850 and consume it (see reference 860) or serve it to others. Moreover, as reference 864 illustrates, the user can elect to repeat some or all of method 800. If the users does not wish to repeat method 800 and/or at other times, the user can clean the sandwich making apparatus and/or the counter 116. But, note, since the sandwich making apparatus 200 prepared the sandwich, little (if any) mess should be present. Indeed, the only thing that would have any foreign material on it would be the tray 212 and that would only be residue from the bread 204 in most scenarios.

There is a chance, though, that some of the foodstuff 300 might have found its way to the tray 212 also. But, that chance is relatively small for a variety of reasons. First, the positions of the tray 212, the reach of the actuator 404, the programming of the controller, etc. can be chosen so that the dispense nozzle will be over the bread 204 with some selected (positive) tolerance to prevent such occurrences. Also, the pause of the roller 416 and the volume of the nozzle plenum 604 prevent sputtering of the foodstuff 300 as it begins to flow and/or flows. Moreover, the channels 614 further restrain sputtering, flow surges, etc. which might lead to splattering in the working area 203. Further still, the material for the foodstuff package 600 and the foodstuffs 300 can be selected such that residual amounts of the foodstuff 300 will have a tendency to adhere to the foodstuff bag 600 and, therefore, not drip. Additionally, or in the alternative, the working area 201 can be configured to allow users to withdraw foodstuff bags 600 of embodiments without the users or the bags being likely to touch any surfaces.

Nonetheless, components (such as the tray 212, the slide plate 304, the cover 206, the roller 416, etc.) that might come in contact with the bread 204 and/or foodstuff 300 can be made of materials that can be washed with water, soap and water, bleach, bleach and water, ammonia-based cleaners, etc. Moreover, some components (such as the tray 212) can be configured to be readily removed from the sandwich making apparatus 200 for further cleaning, sterilization, etc. See reference 866.

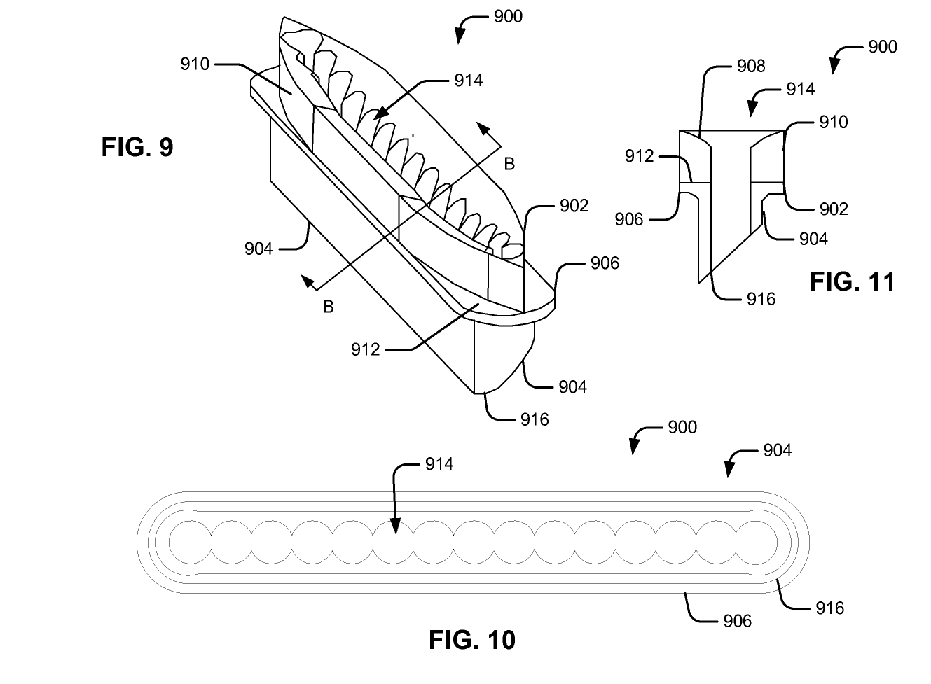

FIG. 9 illustrates a perspective view of a fitment for a foodstuff package. Meanwhile, FIG. 10 illustrates an end view of a fitment for a foodstuff package and FIG. 11 illustrates a cross-sectional view of a fitment for a foodstuff package as seen along line BB of FIG. 6. More specifically, FIGS. 9-11 illustrate a fitment 900, a bag adaptor 902, a dispense nozzle 904, a bag lip 906, a foodstuff entrance guide 908, an adaptor surface 910, a lip surface 912, channels 914, and a nozzle surface 916. Fitments 600 of the current embodiment can be used with foodstuff packages instead of, or in addition to, integral dispense nozzles 606. For instance, some foodstuff packages can include features similar to the foodstuff volume 602, the temporary seal 603, nozzle plenum 604, etc. of the foodstuff bag 600 illustrated by FIG. 6. However, instead of features distal therefrom, foodstuff packages of the current embodiment can define an opening into which the fitment 900 of FIG. 9 fits. Thus, the bag adaptor 902 can be positioned at the proximal end of the fitment 900 and can be shaped to fit into such openings of various foodstuff packages. Moreover, the material of the bag adaptor 902 can be made of a material suitable for heat-based “welding” to these foodstuff packages. In the alternative, or in addition, an adhesive can be used to affix, and/or seal, the fitment 900 of the current embodiment to a foodstuff package.

Furthermore, the bag adaptor 902 can join to, couple to, be formed integrally with, etc. the bag lip 906. That bag lip 906 (in the current embodiment) can extend sufficiently from the adaptor surface 910 to provide another surface (the lip surface 912) against which the foodstuff package can rest, bear, adhere, and/or abut. The lip surface 912 can also provide the distal end of the foodstuff package protection against physical/mechanical abuse, damage, deterioration, etc. It can also provide additional surface to which the package can be welded, adhered, etc. In addition, or in the alternative, the bag lip 906 can provide orientation/registration functionality to the package/fitment 900 assembly, its component parts, the package/sandwich making apparatus combination, etc.

With continuing reference to FIG. 9, the body adaptor 902 can also define the foodstuff entrance guide 908. For instance, the body adaptor 902 can define an angled, beveled, arcuate, chamfered, etc. surface (or set of surfaces) which guides flowing foodstuff 300 from the package into the channels 914. The contour, camber, etc. of the surfaces associated with the foodstuff guide 908 can be designed in accordance with the viscosity, consistency, maximum particle size, etc. of the foodstuff(s) selected for use with the fitment and/or vise versa.

With continuing reference to FIG. 9, the channels 914 extend from the foodstuff entrance guide 908 through the fitment 900 and to the distal end of the dispense nozzle 904 (See FIG. 10). Thus, they allow foodstuff 300 to flow through the fitment 900. Moreover, they can be configured in accordance with the fluid/mechanical properties of one or more foodstuffs 300. For instance, in non-limiting fashions they can be about ¼ to 5/16 inches in diameter and can have relatively smooth surfaces. For instance, the fitment can be blow molded, injection molded, etc. with surface finishes of commercially available quality or otherwise.

With regard to the dispense nozzle 904, it extends from the bag lip 906 and defines the distal end of the fitment 900. More specifically, the dispense nozzle 904 defines an angled, chamfered, arcuate, or otherwise shaped nozzle surface 916. In the current embodiment, the nozzle surface is more or less planer in nature and defines an angle (other than 90 degrees) with the longitudinal axis of the fitment 900. It has been found that the angled nozzle surface 916 improves the shearing of the foodstuff 300 at the conclusion of a dispense cycle. Thus, less dripping of the foodstuff 300 is likely to occur with fitments 900 of the current embodiment than might otherwise be the case. It also tends to reduce the formation of “strings” of foodstuff 300 forming between the dispense nozzle 904 and bread 204 as the bread 204 moves relative to the dispense nozzle 904. Accordingly, cleanliness can be enhanced by such nozzle surfaces 916. Additionally, the angle of the nozzle surface 916 can be adjusted to correspond to the angle between the overall carriage 415 (see FIG. 4) and slide plate 304.

FIG. 12 illustrates a schematic diagram of a control system for a sandwich making apparatus. At this juncture a few words might be in order about the control system 1200 and/or other systems, apparatus, etc. used to control sandwich making apparatus of embodiments. The type of control system 1200 used for such purposes does not limit the scope of the disclosure but certainly includes those now known as well as those which will arise in the future. But usually, these control systems 1200 will include some type of display 1208, keypad 1210, interface 1212, processor 1214, memory 1216, and bus 1218.

Indeed, any type of human-machine interface (as illustrated by display 1208 and keypad 1210) will do so long as it allows some or all of the human interactions with the control system 1200 as disclosed elsewhere herein. Similarly, the interface 1212 can be a network interface card (NIC), a WiFi transceiver, an Ethernet interface, etc. allowing various components of control system 1200 to communicate with each other and/or other devices. Furthermore, the control system 1200 could be a stand-alone device without departing from the scope of the current disclosure.

Moreover, while FIG. 12 illustrates that the control system 1200 includes a processor 1214, the control system 1200 might include some other type of device for performing methods disclosed herein. For instance, the control system 1200 could include a microprocessor, an ASIC (Application Specific Integrated Circuit), a RISC (Reduced Instruction Set IC), a neural network, etc. instead of, or in addition, to the processor 1214. Thus, the device used to perform the methods disclosed herein is not limiting.

Again with reference to FIG. 12, the memory 1216 can be any type of memory currently available or that might arise in the future. For instance, the memory 1216 could be a hard drive, a ROM (Read Only Memory), a RAM (Random Access Memory), flash memory, a CD (Compact Disc), etc. or a combination thereof. No matter its form, in the current embodiment, the memory 1216 stores instructions which enable the processor 1214 (or other device) to perform at least some of the methods disclosed herein as well as (perhaps) others. The memory 1216 of the current embodiment also stores data pertaining to such methods, user inputs thereto, outputs thereof, etc. At least some of the various components of the control system 1200 can communicate over any type of bus 1218 enabling their operations in some or all of the methods disclosed herein. Such buses include, without limitation, SCSI (Small Computer System Interface), ISA (Industry Standard Architecture), EISA (Extended Industry Standard Architecture), etc., buses or a combination thereof.

In addition, the control system 1200 of the current embodiment includes various sensors such as cover sensor 1220, clamp sensor 1222, foodstuff bag sensor 1224, bread sensor 1226, and tear-off sensor 1228. It also includes various drivers such as actuator motor 1230 and roller motor 1232. The sensors 1220, 1222, 1224, 1226, and/or 1228 can be any type of sensor capable of performing various functions describe herein. For instance they could be mechanical switches, photo-sensors, proximity switches, proximity sensors, position sensors, etc. without departing from the scope of the current disclosure. More specifically, the cover sensor 1220 could be a mechanical switch positioned to sense the closure of a latch securing the cover 206 against the guard 208. Likewise, the clamp sensor 1222 could be a mechanical switch positioned to change position responsive to the movement of the clamp. The foodstuff bag sensor 1224, bread sensor 1226, and/or tear-off sensors could be photo-sensors positioned to sense, respectively, the foodstuff package 202 or bag, the bread 204, and the tear-off strip 618 being in their correct, respective, positions.

Additionally, or in the alternative, the control system 1200 could include position sensors for the actuator 404 and roller 416. The actuator sensor 1234 and the roller sensor 1236 could be linear position sensors which convert the position of their respective components to a variable resistance, voltage, current, etc. Thus, the control system 1200 of embodiments includes sensors and actuators to monitor and control the functions of sandwich making apparatus of embodiments.

Moreover, the current disclosure provides sandwich making machines and related apparatus, systems, and methods. These devices can relieve users of some or all of the tasks related to making sandwiches while reducing the amount of cleaning often required following the making of sandwiches. They might therefore reduce the transmission of food borne allergies and illnesses, reducing cross contamination of foods, while freeing up labor for other purposes. Additionally, they can provide portion control to an extent not heretofore conveniently achievable in many settings while also being fun to operate.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. An automated sandwich making machine comprising:
a tray adapted to hold a piece of bread;
a bag-fixation feature adapted to fix a position of a sealed bag of flowable foodstuff in at least one direction relative to the tray;
a press adapted to press the bag of flowable foodstuff, the tray being vertically spaced apart and being positioned relative to the tray such that the foodstuff will flow onto the piece of bread when the tray holds the piece of bread and the press presses the bag and wherein, when the press presses the bag, the seal of the bag opens;
a drive operatively coupled to the press and to the tray and being adapted to drive the press and to drive the tray so as to spread the foodstuff onto the piece of bread when the tray holds the bread and the drive drives the relative motion; and
a controller in communication with the drive and being configured to control the drive whereby a user can place a piece of bread in the tray and the automated sandwich making machine will spread the foodstuff onto the piece of bread.

2. An apparatus comprising:
a tray adapted to hold a piece of bread;
a press adapted to press a bag of at least partially flowable foodstuff, the tray being positioned relative to the press such that the foodstuff will flow onto the piece of bread when the tray holds the piece of bread and the press presses the bag; and
a drive operatively coupled to the tray and the press and being adapted to drive relative motion between the tray and the press so as to spread the foodstuff on the piece of bread when the tray holds the bread and the drive drives the relative motion.

3. The apparatus of claim 2 wherein the press further comprises a roller.

4. The apparatus of claim 2 further comprising a bag-fixation feature adapted to fix the position of the bag in at least one direction relative to the tray.

5. The apparatus of claim 2 further comprising a registration feature adapted to mate with a corresponding registration feature of the bag.

6. The apparatus of claim 5 wherein the registration feature of the apparatus is bite-shaped.

7. The apparatus of claim 2 further comprising a controller in communication with the drive and being configured to control the drive.

8. The apparatus of claim 2 wherein the relative motion between the tray and the press is due to motion of the tray.

9. The apparatus of claim 2 wherein the press is positioned to vertically space apart the bag and the tray.

10. The apparatus of claim 2 further comprising a guard positioned relative to the press, the drive, and the tray to at least partially enclose the press, the drive, and the tray.

11. A system comprising:
at least one bag adapted to contain an at least partially flowable foodstuff and being sealed; and
a sandwich making apparatus further comprising,
a tray adapted to hold a piece of bread;
a press adapted to press the bag, the press being positioned relative to the tray such that the foodstuff will flow onto the piece of bread when the tray holds the piece of bread and the press presses the bag; and
a drive operatively coupled to the tray and to the press and being adapted to drive relative motion between the tray and the press so as to spread the foodstuff on the piece of bread when the tray holds the bread and the drive drives the relative motion.

12. The system of claim 11 wherein the press further comprises a roller.

13. The system of claim 11 further comprising a bag-fixation feature adapted to fix the position of the bag in at least one direction relative to the tray.

14. The system of claim 11 further comprising a registration feature of the sandwich making apparatus is adapted to mate with a corresponding registration feature of the bag.

15. The system of claim 14 wherein the registration feature of the bag is bite-shaped.

16. The system of claim 11 further comprising a controller in communication with the drive and being configured to control the drive.

17. The system of claim 11 wherein the relative motion between the tray and the press is due to motion of the tray.

18. The system of claim 11 wherein the sandwich making apparatus is further adapted to vertically space apart the bag and the tray.

19. The system of claim 11 further comprising a guard positioned relative to the press, the drive, and the tray to at least partially enclose the press, the drive, and the tray.

20. The system of claim 11 wherein the press is positioned at an angle to the tray and the bag defines a beveled nozzle further defining an angle which corresponds to the angle of between the press and the tray.
